(19) United States
(12) Patent Application Publication
(10) Pub. No.: US 2005/0026109 A1
(43) Pub. Date: Feb. 3, 2005

(54) Multi-tapered dental files

(76) Inventor: L. Stephen Buchanan, Santa Barbara, CA (US)

Correspondence Address: Henry M. Bissell, Suite 106, 6820 La Tijera Boulevard, Los Angeles, CA, 90045, US

(21) Appl. No.: 10/630,028

(22) Filed: Jul. 30, 2003

(51) Int. Cl. A61C 5/02

(52) U.S. Cl. 433/102

(57) ABSTRACT

A series of multi-tapered files is disclosed for endodontic use. The files comprise at least two sections, a first portion adjacent the tip of the file and a second portion adjacent the shank. The two portions have different tapers. The files are provided in sets of at least four with the tapers of the first portions of all of the files decreasing incrementally from the first to the last file of the set. In some of the sets, the tapers of the second portions are the same from file to file, being fixed at one of two selected tapers. In other sets, the tapers of the second portions increase from file to file as the tapers of the first portions decrease.

### CROSS-REFERENCE TO RELATED APPLICATION

This application claims the benefit of U.S. Provisional Application Ser. No. 60/266,066, filed Feb. 5, 2001.

This application is the U.S. national phase application from PCT application Serial No. PCT/US02/03516.

The present invention relates generally to endodontic instruments and, more particularly, to root canal files used in the cleaning of material present in the root canal of a human tooth and for enlarging and shaping the root canal so that it may be prepared for filling.

A relatively common but difficult dental procedure is the shaping, cleaning, and filling of the root canal of a patient's tooth. In the performance of a root canal procedure, a hole is first cut in the crown or exposed portion of the tooth, typically either in the biting surface of the tooth, for posterior teeth, or in the side of the tooth on the interior of the jaw for incisor teeth. Small endodontic instruments known generally as root canal files are then used to clean out the material present in the root canal, and to impart a tapered shape to the root canal so that filling material may be inserted into the root canal to seal it.

When a root canal is being cleaned and shaped, in one particular preparation system, a series of files having increasing diameters are used to gradually enlarge the root canal. The files are held between the thumb and forefinger of one hand by the dentist. Each file in one set of the known prior art has an identical taper from one end to the other of the cutting flutes portion. For example, in a typical K-type file set the taper is 0.32 millimeters on every file over the standard 16 mm length of cutting flutes, or 0.02 mm of taper/mm of flute length. This taper is sometimes referred to as a standard ISO (International Standards Organization) taper. Although these file sets have identical tapers, they come in a number of sizes. The size number characterizing the file is the diameter of the file at the tip in hundredths of a millimeter, and the diameter of the file at the large end is thus 0.32 millimeters greater than this tip diameter. A complete set will include sizes 06, 08, 10, 15, 20, 25, 30, 35, 40, 45, 50, 55, 60, 70, 80, 90, 100, 110, 120, 130, and 140, while sizes 08-60 will typically be used. Some manufacturers make certain half-sizes, or off-standard sizes.

Root canals are seldom straight and there is always the possibility of causing irreversible damage to roots and root canals during shaping procedures, depending on the thinness of the root and severity and location of the root canal curvatures. If too large a file is advanced too far into a curved root canal, it may easily cut through the side of the root, which is referred to as a perforation of the root, and usually the tooth must then be extracted.

Another cause of root perforation is the inadvertent introduction of large engine-driven Gates-Glidden or Peezo burs into the middle third of thin, curved roots. Quite often, when these burs are new and sharp, the operator will intend to use one of the larger sizes only at the orifice of the canal but will helplessly watch the bur grab the canal walls and pull itself into dangerous depths in the root.

While perforation is probably the worst outcome of mistakes in shaping procedures, there is a more common problem in near-perforations and root weakening caused by overzealous widening of the canal preparation. It is well documented in the endodontic literature that adequate shape in the cervical two-thirds of the canal preparation is mandatory to accomplish adequate cleaning of the canal, to provide necessary control of instruments in the delicate apical regions of the canal, and to effectively obturate the whole root canal space. However, it is difficult to determine the fine line between creating adequate access and dangerous over-instrumentation, as all of these procedures are accomplished in microscopic root canal systems that are hidden from direct view.

Furthermore, if the tip of the file does not follow the curvature of the canal and bores a passage branching out from the root canal, which is referred to as ledging, surgical correction of the problem is often necessitated. It is thus apparent that the art of root canal shaping is one which requires great skill to prevent damage to the tooth and to create a tapered canal preparation conducive to ideal filling of the canal.

One technique used with a conventional set of files having identical tapers to clean and shape the root canal is referred to as the “step-back” technique. A series of file sizes from 08 to 60 (12 instruments) are introduced into the canal from smallest to largest with each successively larger file being used farther back from the end of the canal. Additionally, between four and six sizes of Gates-Glidden or Peezo burs are similarly used in this step-back manner, comprising a total of 16 to 18 instruments.

An improvement of the step-back procedure is disclosed in my U.S. Pat. No. 6,053,735, entitled ROOT CANAL PREPARATION METHOD, the disclosure of which is incorporated herein by reference as though set out in haec verba. The disclosed improved endodontic procedure includes using either files or burs in a first crown-down procedure, then using the instruments in a reverse sequence in a serial step-back procedure, followed by finishing preparation of the root canal with selected instruments in a second crown-down procedure. Either conventional root canal files of standard taper or variably-tapered files may be used.

My prior U.S. Pat. No. 5,897,316 discloses the use of variably-tapered files in what is referred to as the Greater Taper System™. The disclosure of that patent is incorporated by reference herein as though set out in haec verba.

The purpose of endodontic shaping procedures is to create a continuously tapering preparation which is narrowest at the end of the canal, and widest near the crown of the tooth. By using files that vary in their tapers, it has been determined that root canals may often be prepared by using a single shaping file instead of the 16 to 18 files required by conventional ISO-tapered instruments. While it is readily apparent that the use of only one tool instead of 16 to 18 tools is desirable from the standpoint of efficiency, it should also be noted that the use of variably tapered files provides for ideal root canal shaping results by practitioners having less training and experience. Rather than creating a tapered canal shape by the difficult and time-consuming step-back technique, the Greater Taper System™ simply requires that a shaping instrument of appropriate taper be worked to the full length of the canal. In addition to the greatly improved ease and simplicity of shaping canals with a single instrument, this provides, for the first time, a pre-defined shape throughout the full length of the canal.

One of the most important advantages provided by pre-defined root canal preparations is the resultant ability to optimize cleaning and filling procedures in root canal systems. Since the design of files taught by the Greater Taper System™ involves different tapers, the tips of the shaping files are not used to cut a path in the canal as in files with standard tapers. Whereas standard ISO file sets have the same tapers but increasing tip diameters in the sequence of files, the tip diameters of a set of shaping files of the Greater Taper System™ may be the same for files of different tapers. There may also be different sets of these shaping files which differ in their tip diameters, i.e. one set of shaping files with tapers of 0.04, 0.06, 0.08, 0.10, and 0.12 mm/mm and the same 0.2 mm tip diameters; another set of shaping files with the same range of tapers but with 0.35 mm tip diameters, etc. And finally, the Greater Taper System™ includes sets of shaping files with similar non-ISO tapers which vary by evenly or proportionally increasing tip diameters.

Moreover, shaping files of the Greater Taper System™ can be safely used in curved canals and/or thin roots in spite of their greater rates of taper. This is accomplished very effectively by the specification of progressively shorter flute lengths as files in a set have progressively greater tapers, thereby limiting their maximum flute diameters. Without this feature, the shank-end flute diameters of variably-tapered shaping files become wider and stiffer as the tapers of these instruments increase, and their potential for lateral perforation or weakening of the root increases as well.

While limiting the maximum flute diameter of these increasingly tapered shaping files allows their safe use, this feature is extremely important in a broader sense. Using a single shaping file instead of the usual 15-18 instrument set means that the final shape through the full length of that canal is pre-defined, unlike the shaping result when six different sizes of Gates-Glidden burs are used progressively shallower in the coronal portions of the root canal. It is extremely common for Gates-Glidden and Peezo burs to be used too deeply in thin roots, risking weakening and perforation. Simply limiting the maximal flute diameters of shaping files allows, for the first time in the field of endodontics, enlargement of the coronal two-thirds of a canal to an extent that is exactly adequate to clean the tiny apical regions of the canal and to maintain control of shaping and filling instruments in that region, but not a bit larger.

When shaping files are used with rotary cutting motions two primary problems are encountered, potential for breakage and slowness of cutting. This is overcome in the Greater Taper System™ by varying the flute pitch from an in-line reamer-like angle at the shank end of the instrument to a more perpendicular K-type flute angle at the file tip. Instead of, or in addition to, the above, the relative sharpness of the cutting flutes is varied along the length of the files, being sharpest at the strong shank end to allow for aggressive cutting by the wider flutes, and dullest near the smaller, more fragile tip of the file so these flutes can easily release from the canal wall during rotation, thereby preventing file breakage which can occur when the tip binds.

Despite the many benefits from using the files of the Greater Taper System™ and the substantial improvements in those files as noted hereinabove, they still involve files having a constant or fixed taper from shank to tip despite the variability of taper from file to file. I have found that there are occasions when the preparation of a particular root canal calls for a certain taper in one portion and a different taper in another portion which at present requires that different files be used to achieve the objective. I have devised a multi-tapered file which presents at least two different taper angles at different points between tip and shank which substantially improve efficiency in preparing a root canal. This multi-tapered file can be used to advantage in each of the procedures described hereinabove, as well as in other procedures in the general field of endodontics.

In brief, particular arrangements of the present invention comprise tapered root canal files having at least two different angles or degrees of taper along different portions of their flute sections. For example, one particular file in accordance with the present invention comprises a first portion adjacent the tip of the file which has a 0.12 taper. This extends over a selected distance back from the tip to a second portion adjacent the shank in which the taper changes to a 0.02 taper (the standard ISO taper). This file is one of a set of four, all having the same lengths from file to file for the first and second portions, respectively, and the same 0.02 taper for the second portions, but in which the taper of the first portion diminishes from file to file. The first file is that having the 0.12 taper for the first portion. The next file has 0.10 taper for the first portion with the third and fourth files having a first portion taper of 0.08 and 0.06, respectively. A second set of files is exactly like the just-mentioned set in all respects except for the taper in the second portion being established at 0.04 mm/mm. For purposes of distinguishing nomenclature, these two sets of files will be designated as being in a first Group of files.

In another arrangement in accordance with the present invention, multi-tapered files are provided in two similar sets of four which have their first portions of varying lengths; i.e. extending varying distances back from the tip. Since the length of the cutting portion of the file is the same from file to file, as the length of the first portion increases with diminishing tapers of 0.12, 0.10, 0.08 and 0.06, respectively, the lengths of the second portions diminish accordingly. As with the two sets of files in the first Group, these two sets of files are provided with tapers of 0.02 and 0.04 mm/mm, respectively, over the extent of the second flute portion adjacent the shank. These two sets of files will be referred to as being in a second file Group.

A third Group comprises a single set of four files which, like the first Group files, have equal lengths from file to file of the first and second portions respectively. However, in this third Group, the taper of the second portion varies inversely with the variation in taper of the first portion from file to file. That is, as the taper of the first portion of the Group III files diminishes from 0.12 for the first file through 0.10 and 0.08 to 0.06 for the fourth file, the taper of the second portion increases from 0.01 mm/mm for the first file through 0.02 and 0.03 to 0.04 mm/mm for the fourth file.

The files of a fourth Group are like the files of the second Group in that the lengths of the first and second portions vary from file to file; i.e., beginning with the first file, which has the shortest first portion and thus the longest second portion, the length of the first portion increases from file to file while the length of the second portion decreases correspondingly. The taper of the first portion reduces from file to file, starting with a 0.12 taper, and reducing progressively to 0.06 taper in the fourth file. In this fourth Group, unlike the second Group where the taper of the second portion is the same from file to file in a given set, the taper of the second portion increases from file to file as the taper of the first portion reduces. Thus, for files in the fourth Group, as the taper of the first portion reduces from 0.12 through 0.10 and 0.08 to 0.06 the tapers of the second portion are increasing from file to file. For a file in the fourth Group having a first portion taper of 0.12, the taper of the second portion is 0.01. For the second file, which has a first portion taper of 0.10, the taper of the second portion is 0.02. For the third file with a first portion taper of 0.08, the second portion taper is 0.03. The fourth file has a first portion taper of 0.06 while the taper of the second portion is 0.04.

Thus, arrangements in accordance with the present invention provide multi-tapered sets of four files each. They may extend to sets of five or six, where appropriate. For purpose of disclosure, these are organized in Groups I-IV. Some of the Groups comprise two sets of files; some comprise a single set, each having at least two portions of distinctly different tapers. In each set, the tapers of the first portions vary from one file to the next, beginning with a taper of 0.12 for the maximum taper file and decreasing successively through 0.10 and 0.08 to the minimum taper file of 0.06 in the first portion. Where the sets extend to five or six files, the minimum taper of the first portion is 0.04 or 0.02, respectively. In Groups I and II, one set comprises files having a standard taper of 0.02 in the second portions thereof, while the other set provides a taper of 0.04 in the second portions of the files.

The groups may also be distinguished by the respective lengths of the two portions of a particular file. In Groups I and III, the first portions of the files are all the same length. The lengths of the second portions are also consistent from file to file. In the other Groups of files, the length of the first portion is shortest for the greatest taper (0.12) and increases correspondingly as the taper of the first portion of the files reduces to the minimum taper at 0.06, with the lengths of the second portions being adjusted accordingly. There may be additional files where the taper of the first portion is 0.04 or 0.02, where appropriate.

In other Groups of files (Groups III and IV), the tapers of the second portions of the files in a given set are not fixed but vary inversely with the tapers of the first portions; i.e., as the tapers of the first portions reduce from file to file, the tapers of the second portions increase.

In Groups II and IV, the location of the change between tapers of the first and second portions varies in distance from the tip. As that distance increase, from file to file, the length of the second portions diminishes accordingly.

It is possible to incorporate this multi-taper feature in the various versions described above in files having various types or forms of flutes, such as the K-type files and the Hedstrom-type files described hereinabove. Moreover, the multi-taper feature of the present invention may be incorporated in files having one or more helicoidal flutes or in files having at least a single axial cutting edge.

One particular benefit of these particular arrangements in accordance with the present invention stems from their ability to clean out and shape the coronal portion of a root canal, after which the flute portion adjacent the shank takes over the shaping of the remaining portion of the root canal, maintaining the desired taper of the second portion of the selected file as the file is moved farther into the root canal.

### IN THE ACCOMPANYING DRAWINGS

FIG. 1 is a schematic view of a root canal in a tooth, with a portion to be removed during root canal shaping procedures shown in broken lines;

FIG. 2 shows a conventional ISO file of the prior art;

FIGS. 3A-3D are schematic views of a first Group of four multi-taper files in accordance with the present invention;

FIGS. 4A-4D are schematic views of a second Group of four multi-taper files in accordance with the present invention;

FIGS. 5A-5D are schematic views of a third Group of four multi-taper files in accordance with the present invention;

FIGS. 6A-6D are schematic views of a fourth Group of four multi-taper files in accordance with the present invention; and

FIGS. 7A-7D are schematic cross-sectional views of four different cross-sectional shapes for the cutting flutes of the multi-taper files of the present invention.

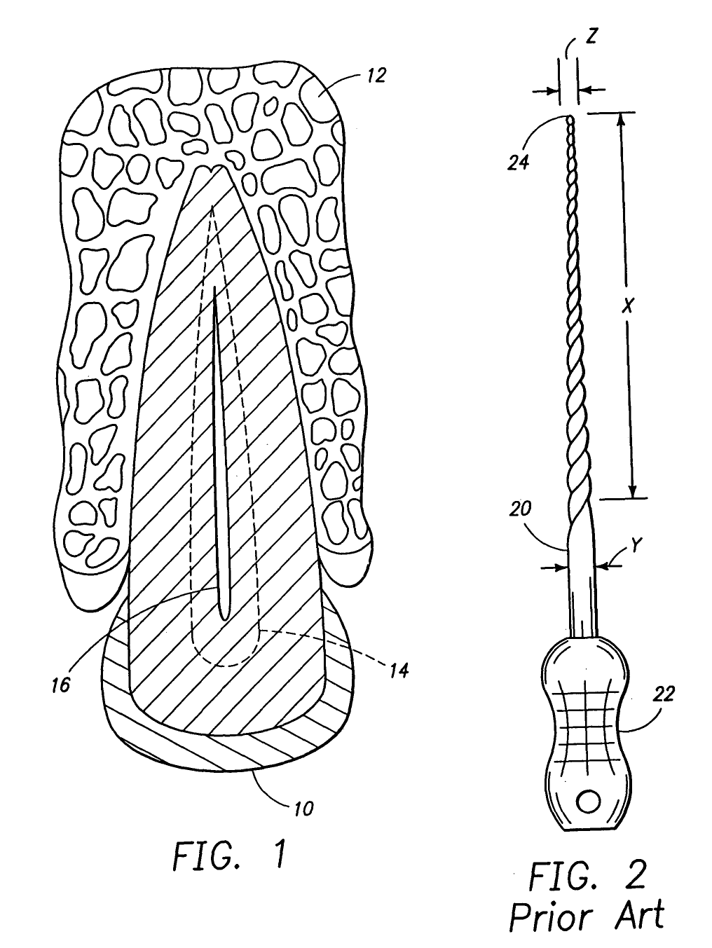

In the schematic diagram of FIG. 1, a tooth 10 is shown located in the bone 12 of a patient's jaw. The tooth 10 is an incisor, and the opening in the crown of the tooth 10 is cut on the side of the tooth in the interior, which opening is generally indicated at 14. The tooth 10 has a nerve canal 16 extending to the tip of the tooth which is embedded in the bone 12. In the preparation of a root canal, the nerve canal 16 and surrounding portion within the broken outline 14 is to be removed, for subsequent filling with materials used in completion of the root canal.

FIG. 2 shows a conventional root canal file of the prior art having a handle 22 supporting the file 20. The file has a flute length X, a shank diameter Y and a tip diameter Z. In a standard ISO file of this type, X equals 16 mm, Y equals 0.32 mm plus Z, and Z varies with the size of the file, beginning at 0.06 mm for the smallest file and increasing to 1.4 mm for the largest file. The smallest file has a sharp tip 24, which is needed since each successive file in the series has a larger diameter at the tip.

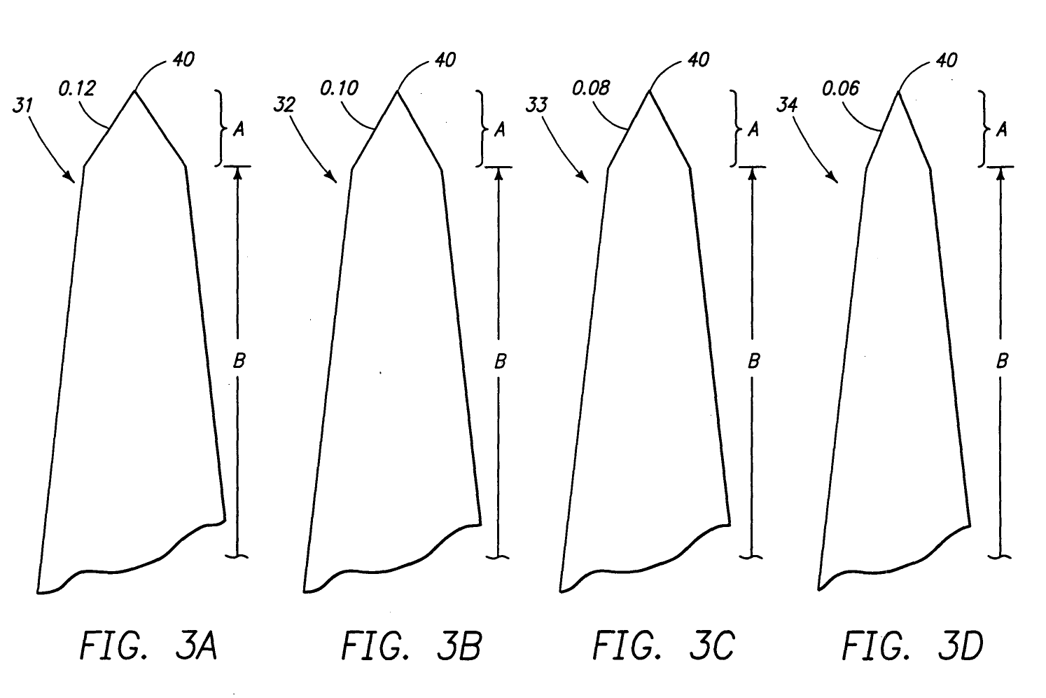

FIGS. 3A-3D schematically represent sets of four multi-tapered files 31, 32, 33 and 34 in accordance with the present invention. Each of the files is shown with a first portion A adjacent the tip 40 and a second portion B remote from the tip, extending back to the shank, not shown. The portions A and B have different tapers in the same file and the taper in the first portion also varies from file to file. In file 31 the taper of the first portion is 0.12. In file 32, the taper of the first portion is 0.10. In file 33, the taper of the first portion is 0.08. In file 34, the taper of the first portion is 0.06. For smaller files the taper of the first portion may be 0.04 or 0.02, as appropriate. The same variation of taper of the first portion from file to file of a given set applies to all of the file sets disclosed herein.

In a first set of files represented by FIGS. 3A-3D, the taper of the second portion B is 0.02 mm/mm. In a second set of files, also represented by the drawings of FIGS. 3A-3D, the taper of the second portion B is 0.04 mm/mm. The files of FIGS. 3A-3D are the Group I files discussed hereinabove.

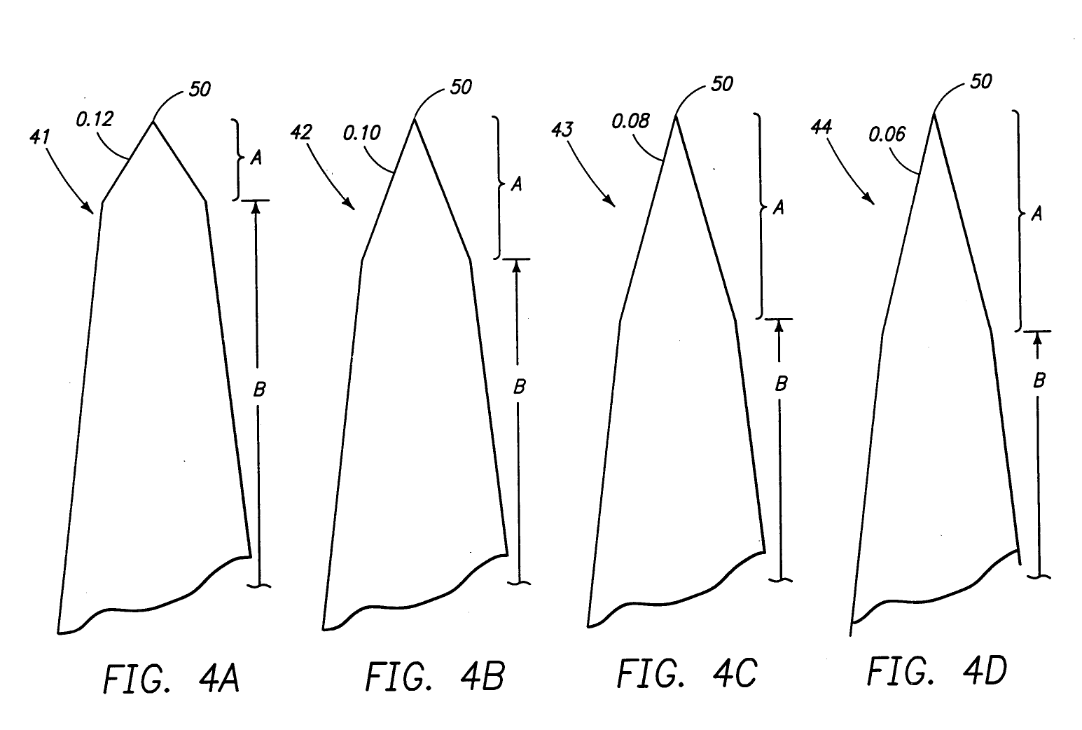

FIGS. 4A-4D schematically represent different sets of files from those of FIGS. 3A-3D. These are the Group II files discussed above. FIGS. 4A-4D show files 41, 42, 43 and 44 in a multi-tapered configuration. In each of the files 41-44, there is a first portion A adjacent the tip 50 and a second portion B remote from the tip, extending to the shank. In these sets of files, each of the first portions is a different length from those of the other first portions, being shortest for the file 41 which has the greatest taper of the first portion A (0.12) and increasing successively for files 42, 43 and 44 as the taper of the first portion diminishes. As with the sets of files 31-34 of Group I, one set of files 41-44 has a taper of 0.02 mm/mm for the second portion B whereas another set has a taper of 0.04 mm/mm for the second portion B.

The respective lengths of the first and second portions of the files of the files of the present invention are determined on the basis of a number of factors, such as the material of the files (whether nickel titanium, stainless steel or some other material), the specific tapers of the first and second portions, file diameters, and the like. Selection of the length L of the first portion fixes the length of the second portion as 16-L_{A} (for a file having a flute length of 16 mm.).

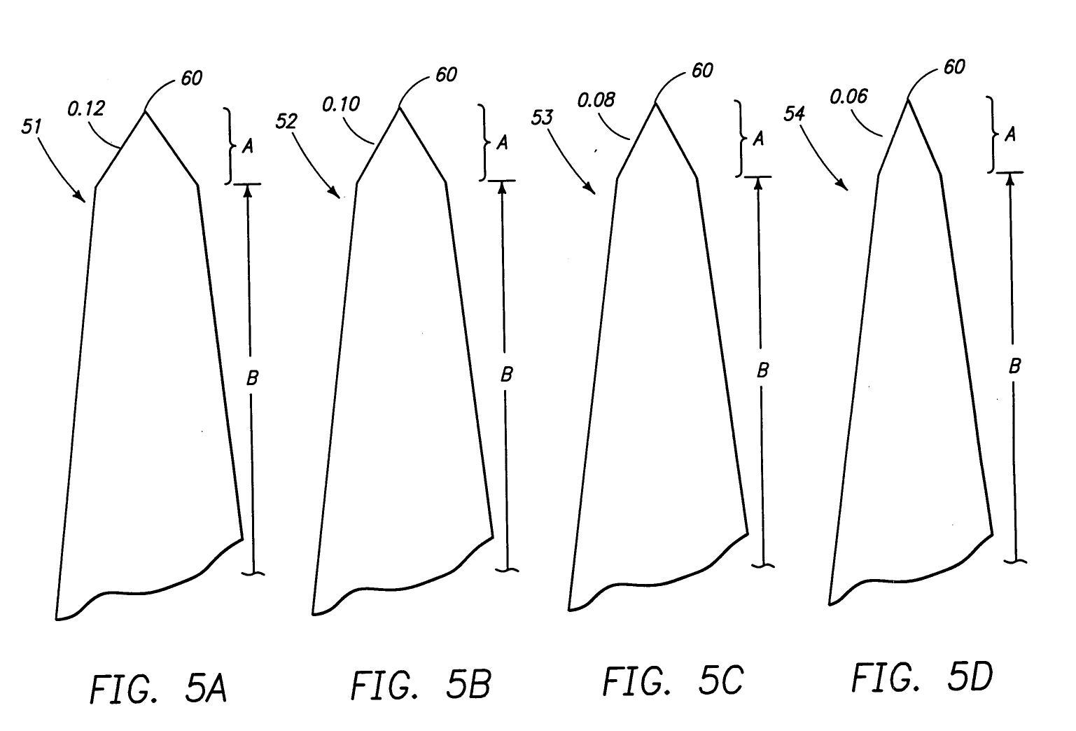

FIGS. 5A-5D schematically represent another set of four multi-tapered files 51, 52, 53 and 54 in accordance with the present invention. Each of the files is shown with a first portion A adjacent the tip 60 and a second portion B remote from the tip, extending back to the shank, not shown. The portions A and B have different tapers in the same file and the taper in the first portion also varies from file to file. In file 51 the taper of the first portion is 0.12. In file 52, the taper of the first portion is 0.10. In file 58, the taper of the first portion is 0.08. In file 54, the taper of the first portion is 0.06.

In these files 51-54, the taper of the second portion varies from file to file, increasing in taper as the taper of the first portion reduces. For the file 51, the taper of the second portion is 0.01 mm/mm; for the file 52, it is 0.02; for the file 53 it is 0.03; and for the file 54 the taper of the second portion is 0.04 mm/mm. The files of FIGS. 5A-5D are the Group III files discussed hereinabove.

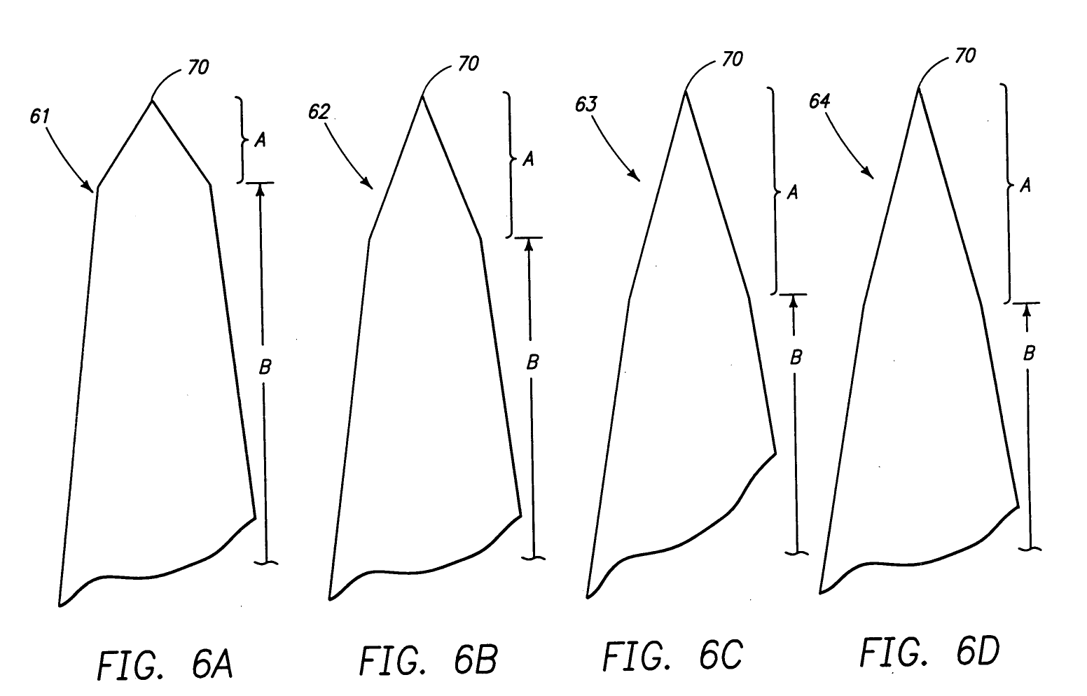

FIGS. 6A-6D schematically represent still another set of files in accordance with the invention, the Group IV files discussed above. FIGS. 6A-6D show files 61, 62, 63 and 64 in a multi-tapered configuration. In each of the files 61-64, there is a first portion A adjacent the tip 70 and a second portion B remote from the tip, extending to the shank. In this set of files, each of the first portions is a different length from those of the other first portions, being shortest for the file 61 which has the greatest taper of the first portion A (0.12) and increasing successively for files 62, 63 and 64 as the taper of the first portion diminishes, beginning at 0.10 for file 61 and extending to 0.06 for file 64. Smaller tapers of 0.04 and 0.02 may be provided in fifth and sixth files, as appropriate, if desired.

Thus the ratio of taper of the first portion to taper of the second portion ranges between 3 and 6 for the set of Group I files with a second portion taper of 0.02. Where the smallest taper of the first portion is 0.02, the range of taper ratios is from 1 to 6.

In these files 61-64, the taper of the second portion varies from file to file, increasing in taper as the taper of the first portion reduces. For the file 61, the taper of the second portion is 0.01 mm/mm; for the file 62, it is 0.02; for the file 63 it is 0.03; and for the file 64 the taper of the second portion is 0.04 mm/mm.

As a result of the use of multi-tapered files in accordance with the invention for the preparation of root canals in teeth, a better result can be obtained in less time and with resort to a lesser number of files. As one of the multi-tapered files is driven deeper into the root of a tooth, different portions of the cutting flute at different depths of the file become effective to shape the root canal to a finished configuration in preparation for receiving the gutta percha or other filling materials.

These files have been described as individual files, having handles of the type shown in FIG. 2. However, these may as well be adapted as instruments for use in powered drives.

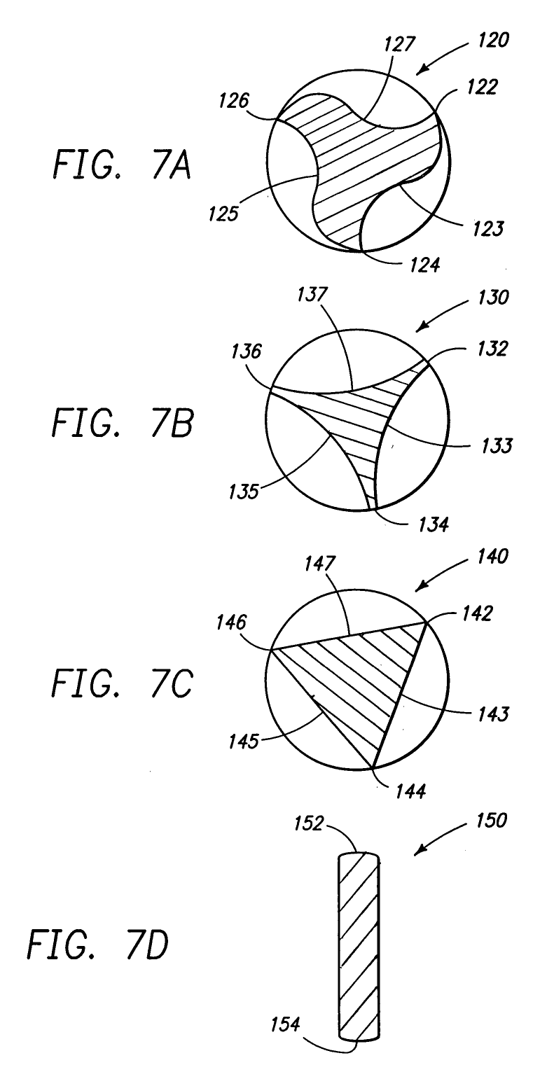

The files may be of different shapes and cross-sectional configurations, corresponding but not limited to the shapes represented schematically in FIGS. 7A, 7B, 7C and 7D.

FIG. 7A shows an instrument 120 in cross section with three cutting edges 122, 124 and 126. Between the cutting edges 122, 124 and 126 are three faces 123, 125 and 127, respectively. These faces are generally shaped in cross section to provide a positive rake angle or improved cutting edges at 122, 124 and 126.

FIG. 7B shows an instrument 130 in cross section with three cutting edges 132, 134 and 136. Between the cutting edges are three faces 133, 135 and 137. Each of the faces is concave in cross section with a radial land as the flute edge. The configuration of FIG. 7B provides improved cutting edges 132, 134 or 136, with reduced manufacturing costs compared to FIG. 7A.

FIG. 7C shows, in cross section, an instrument 140. This instrument has a triangular cross section with planar faces 143, 145 and 147 between cutting edges 142, 144 and 146.

FIG. 7D shows, in cross section, an instrument 150. This instrument, unlike the others, has two opposed cutting surfaces 152, 154.

Although there have been described hereinabove various specific arrangements of a MULTI-TAPERED DENTAL FILES in accordance with the invention for the purpose of illustrating the manner in which the invention may be used to advantage, it will be appreciated that the invention is not limited thereto. Accordingly, any and all modifications, variations or equivalent arrangements which may occur to those skilled in the art should be considered to be within the scope of the invention as defined in the annexed claims.

1. An endodontic file comprising:
a round shank having a first diameter;
a tip at the end of the file remote from the shank, said tip having a second diameter which is smaller than said first diameter; and
a tapered flute portion extending between said tip and said shank and having at least one spiral cutting edge throughout the length thereof;
wherein said tapered flute portion has at least two different degrees of taper in different parts of said flute portion.

2. The file of claim 1 further including a handle affixed to the shank of the file for facilitating the manipulation of the file.

3. The file of claim 1 wherein the shank is provided with a latch-grip portion for coupling to a dental handpiece.

4. The file of claim 1 wherein a first part of said flute portion, adjacent the tip, is provided with a first fixed degree of taper throughout the extent of first said part and a second part of said flute portion, adjacent the shank, is provided with a second fixed degree of taper which is less than the taper of the first part.

5. The file of claim 4 wherein the taper of the first part of the flute portion is larger than the taper of the second part thereof.

6. The file of claim 5 wherein the taper of the second part of the flute portion is 0.02 mm/mm.

7. The file of claim 5 wherein the taper of the second part of the flute portion is 0.04 mm/mm.

8. The file of claim 4 wherein the taper of the first part of the flute portion is 0.12 mm/mm.

9. The file of claim 4 wherein the taper of the first part of the flute portion is 0.10 mm/mm.

10. The file of claim 4 wherein the taper of the first part of the flute portion is 0.08 mm/mm.

11. The file of claim 4 wherein the taper of the first part of the flute portion is 0.06 mm/mm.

12. The file of claim 4 wherein the taper of the first part of the flute portion is 0.04 mm/mm.

13. The file of claim 4 wherein the taper of the first part of the flute portion is 0.02 mm/mm.

14. The file of claim 4 wherein the tapers of the first and second parts of the flute portion are in a selected ratio with respect to each other.

15. The file of claim 14 wherein said ratio is within a range of three to six.

16. The file of claim 12 wherein the degree of taper changes abruptly between the first and second parts of the flute portion.

17. The file of claim 16 wherein the point of demarcation between said first and second parts of the flute portion is at a preselected distance from the file tip.

18. A set of endodontic files, each corresponding to the file of claim 4, wherein the taper of the first part of the flute portion varies from file to file in said set.

19. The set of endodontic files according to claim 18 wherein the range of variation of taper of the first part of the flute portion is from 0.02 mm/mm to 0.12 mm/mm.

20. The set of endodontic files according to claim 18 wherein the range of variation of taper of the first part of the flute portion is from 0.06 mm/mm to 0.12 mm/mm.

21. The endodontic file set of claim 20 wherein the taper of the second part of the flute portion is of a selected value of 0.02 mm/mm.

22. The endodontic file set of claim 20 wherein the taper of the second part of the flute portion is of a selected value of 0.04 mm/mm.

23. The set of endodontic files according to claim 20 wherein the degree of taper of the second part of the flute portion varies from file to file inversely to the variation of degree of taper in the first part of the flute portions of said set.

24. The set of endodontic files in accordance with claim 20 wherein the taper of the second part of said flute portion increases from 0.01 to 0.04 mm/mm as the taper of the first part of said flute portion diminishes from 0.12 to 0.06 mm/mm.
